(19) United States
(12) Patent Application Publication
(10) Pub. No.: US 2026/0070744 A1
(43) Pub. Date: Mar. 12, 2026

(54) ADJUSTABLE FLIGHTS FOR A CONVEYOR

(71) Applicant: Laitram, L.L.C., Harahan, LA (US)

(72) Inventor: Bryant G. Ragan, Metairie, LA (US)

(21) Appl. No.: 19/113,159

(22) PCT Filed: Oct. 2, 2023
(86) PCT No.: PCT/US2023/034257

§ 371 Date: Mar. 19, 2025

Related U.S. Application Data
(60) Provisional application No. 63/412,711, filed on Oct. 3, 2022.

(51) Int. Cl. B65G 47/28; B65G 47/82

(52) U.S. Cl. CPC B65G 47/28; B65G 47/82

(57) ABSTRACT

A conveying system employs a plurality of sets of coordinating flights for controlling the spacing of objects conveyed by a conveyor. Each set of coordinating flights includes a front flight having a rotatable panel that can selectively move into a vertical position for stopping a parcel and a rear flight having a horizontal panel for supporting a parcel from below.

### RELATED APPLICATIONS

The present application claims priority to U.S. Provisional Patent Application Ser. No. 63/412,711, filed Oct. 3, 2022, and entitled “Adjustable Flights for a Conveyor”, the contents of which are herein incorporated by reference.

### BACKGROUND OF THE INVENTION

The present invention relates to the field of power-driven conveyors. More particularly, the invention relates to a system and method for controlling the spacing of conveyed objects.

It is often desirable to space conveyed objects in a selected manner along the travel direction of a conveyor, such as a conveyor belt. The spacing enables downstream processing, such as sorting by diverting of selected objects onto an exit conveyor. For example, it may be desirable to have only one parcel on a section of a conveying system, such as a diverter, at a time. If the parcels are of different sizes, such as often occurs in the shipping industry, then the spacing of parcels should be varied in order to ensure that only one parcels is on the selected section at a time, while maintaining the smallest possible gap between parcels. Alternatively, it may be desirable for the parcels have a uniform spacing, requiring automated equipment to set the parcels at a desired uniform gap.

### SUMMARY OF THE INVENTION

According to one aspect, a dynamic gapping conveyor comprises a frame forming a carryway for a conveying surface, a conveying surface extending in a conveying direction from a first end to a second end and laterally from a first side edge to a second side edge, a first flight and a second flight. The first flight has a rotatable panel extending laterally across the conveying surface for catching a front of a parcel. The first flight is connected to a first mover of a linear transport system. The second flight has a horizontal panel for supporting the parcel from below and is connected to a second mover of the linear transport system.

According to another aspect, a flight for a dynamic gapping conveyor comprises a panel for contacting a parcel, a rod extending from the panel, a cam follower connected to the rod for engaging a track in a frame of the dynamic gapping conveyor, a bearing support housed in a sheath for receiving the rod and a plurality of spring-loaded fasteners for mounting the sheath to a mover, so that raising the cam follower causes the panel to raise relative to the mover.

According to another aspect, a flight for a conveyor comprises a laterally extending panel having a plurality of first hinge elements extending from a first edge, a lateral connecting bar having a plurality of second hinge elements configured to interleave with the first hinge elements, a plurality of longitudinally extending fingers extending from the lateral connecting bar, a hinge rod extending through the interleaved hinge elements, a bearing support mounted to a mover of a linear transport system for rotatably receiving the hinge rod and a cam follower connected to and offset from an end of the hinge rod for engaging a track in a frame of the conveyor so that raising the cam follower rotates the laterally-extending panel to a vertical position.

### BRIEF DESCRIPTION OF THE FIGURES

FIG. 1 is an isometric view of a dynamic gapping conveying system according to an embodiment while conveying a first object and prior to receiving a second object;

FIG. 2 is a side view of the dynamic gapping conveyor system of FIG. 1;

FIG. 3 is an isometric view of the dynamic gapping conveying system of FIG. 1 during reception of the second object on a gapping conveyor;

FIG. 4 is a side view of the dynamic gapping conveyor system of FIG. 3;

FIG. 5 is an isometric view of the dynamic gapping conveying system of FIG. 1 as the second object is loaded onto a gapping conveyor;

FIG. 6 is a side view of the dynamic gapping conveyor system of FIG. 5;

FIG. 7 is an isometric view of the dynamic gapping conveying system of FIG. 1 during gapping of the first object and second object;

FIG. 8 is a side view of the dynamic gapping conveyor system of FIG. 7;

FIG. 9 is an isometric view of the dynamic gapping conveying system of FIG. 1 after setting a gap between the first object and second object on a gapping conveyor;

FIG. 10 is a side view of the dynamic gapping conveyor system of FIG. 9;

FIG. 11 is an isometric view of a front flight of a dynamic gapping conveying system according to an embodiment;

FIG. 12 is an isometric view of the front flight of FIG. 11 in a raised flap position;

FIG. 13 is an exploded view of the front flight of FIG. 11;

FIG. 14 is an isometric view of a rear flight of a dynamic gapping conveying system in a lowered position according to an embodiment;

FIG. 15 is an isometric view of the rear flight of FIG. 14 in a raised position;

FIG. 16 is a side view of an input end of a gapping conveyor with flights in lowered positions;

FIG. 17 is a side view of the input end of FIG. 16 as a first flight is rotated into a stopping position;

FIG. 18 is a side view of a portion of the gapping conveyor near the input end of FIG. 16 before the flights are raised; and

FIG. 19 is a side view of a portion of the gapping conveyor of FIG. 16 after both flights are raised.

### DETAILED DESCRIPTION OF THE INVENTION

A dynamic gapping conveying system includes a plurality of sets of independent flights to control and vary the spacing of conveyed objects. The present invention will be described below relative to certain illustrative embodiments. Those skilled in the art will appreciate that the present invention may be implemented in a number of different applications and embodiments and is not specifically limited in its application to the particular embodiments depicted.

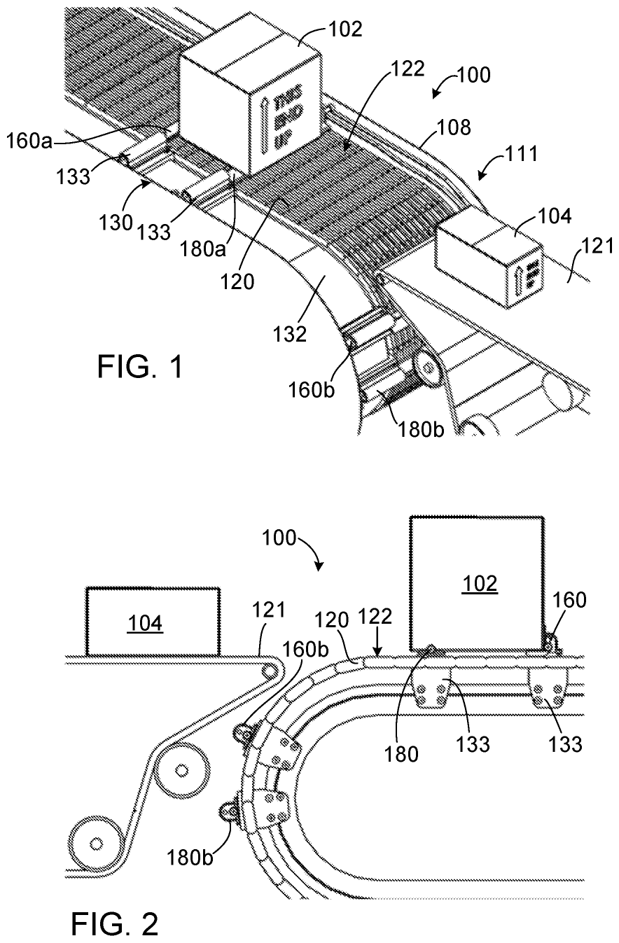

FIGS. 1 and 2 show a dynamic gapping conveying system 100 employing a plurality of sets of dynamic, assignable flights. Each set of flights comprises a front flight designed to stop the forward movement of a parcel (i.e., a “catch flight”) and a rear flight (i.e., a “support flight”) designed to support a parcel from below. The front flight and rear flight coordinate to move a parcel to a desired position on a conveyor. The dynamic gapping conveying system 100 can gap parcels on a conveying surface using the plurality of sets of flights.

The illustrative dynamic gapping conveying system 100 includes a gapping conveyor 120 comprising an endless conveyor belt trained around guide devices at each end of a carryway to define a top conveying surface 122 and having a returnway below the carryway to form a complete circuit. A driver, such as a sprocket driven by a motor, moves the conveyor belt 120 through the circuit to move objects from a first end 111 to the second end. The conveyor carryway extends longitudinally from the first end 111, which is the infeed end, to the second end, which is the outfeed end, and laterally in width from a first side edge to a second side edge.

The gapping conveyor 120 receives a series of objects, such as parcels, at the infeed end 111, gaps the objects relative to each other at a selected spacing, moves the objects to the outfeed end and discharges the objects at a set pace from the outfeed end. A dynamic gapping system 130 runs concurrent with the conveyor 120 and includes a plurality of sets of independent flights for spacing objects conveyed by the conveyor. For example, the dynamic gapping system 130 may control and maintain a consistent gap between parcels of different sizes to increase throughput.

The invention is not limited to a conveyor belt 120 for conveying objects, and any suitable means for conveying objects may be used. For example, the conveyor can comprise a low friction surface, rollers or another suitable conveyor. In one embodiment, the conveyor belt 120 is a raised rib conveyor belt having a series of longitudinal ribs separated by valleys, but the invention is not so limited.

The dynamic gapping system 130 comprises a linear transport system connected to a plurality of flights that extend laterally over the conveying surface 122. The illustrative flights are controlled separately from the conveying surface 122. The illustrative dynamic gapping system 130 comprises two flights for each parcel: a front flight 160 and a rear flight 180. The front flight 160 includes a rotatable panel that may move between a flat position and an upright position for stopping a parcel on the conveying surface 122. The rear flight 180 comprises a raisable and lowerable panel for supporting and selectively lifting a parcel relative to the conveying surface 122.

In an illustrative embodiment of the invention, the flights 160, 180 are driven independently from the conveying surface 122 and each other. In one embodiment, the flights 160, 180 are driven by a linear transport system, comprising a plurality of movers 133 connected to the flights 160, 180 and a motor module for propelling the movers, with each mover 133 individually controlled. An illustrative motor module comprises an endless, obround-shaped rail 132 on a side of the gapping conveyor 122, substantially matching and adjacent the path of the conveyor belt 120, though the invention is not so limited.

Alternatively, the rail 132 could return along a different path, such as above or outside of the carryway. The illustrative rail 132 includes inducers, such as embedded electromagnetic coils or other elements, that cooperate with elements, such as magnetic plates, in the movers 133 to propel the movers through the circuit formed by the rail 132 at a controlled and variable pace. Suitable linear transport systems are available from Rockwell Automation (the iTRACK® intelligent track system), Beckhoff Automation LLC of Savage, MN, B&R Automation of Eggelsberg, Austria, FESTO Corporation of Germany and other linear transport system providers known in the art.

A side wall 108 adjacent the conveyor belt 120 includes tracks or other features for controlling the orientation and-or elevation of the flights 160, 180 at different longitudinal locations along the conveyor 120, as described below.

FIGS. 1 and 2 show the dynamic gapping conveyor system 100 after a first parcel is placed on the gapping conveyor 120 and prior to placing a second parcel on the conveyor 120. In FIGS. 1 and 2, a first parcel 102 is positioned by a first front flight 160a and a first rear flight 180a on the gapping conveyor 120. The first front flight 160a limits the forward movement of the first parcel 102 and the first rear flight 180a supports the first parcel 102 from below. A second parcel 104 is conveyed towards the gapping conveyor 120 by an input conveyor 121. A second set of flights 160b, 180b moves from below the carryway to receive the second parcel 104 when it is discharged by the input conveyor 121. While still traveling around the input end 111, the second front flight 160b is in an unraised, panel down position, and the second rear flight 180b is in an unraised position.

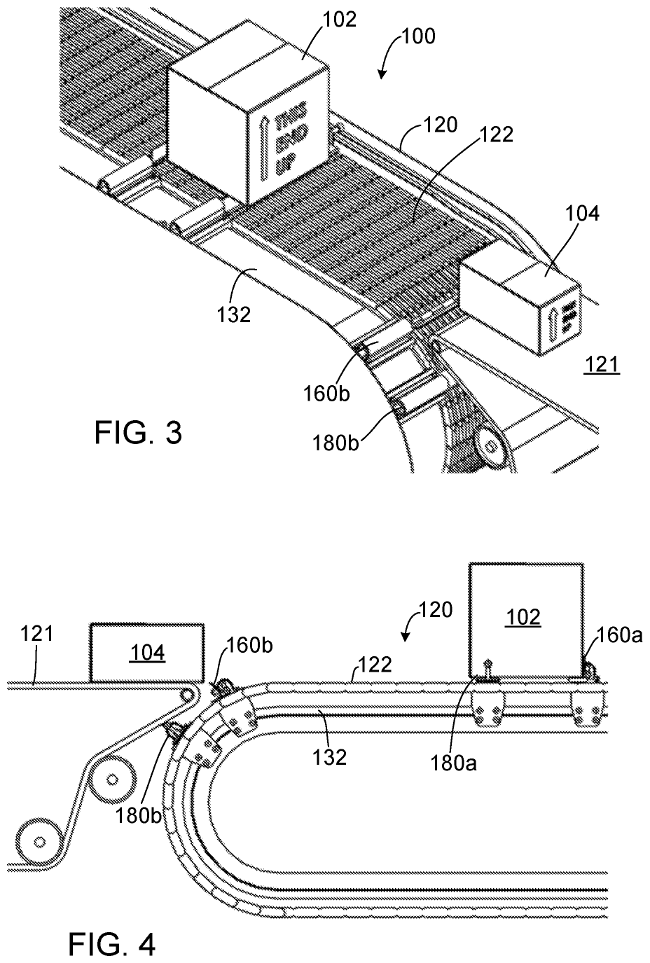

Referring to FIGS. 3 and 4, as the second front flight 160b approaches the carryway, the panel of the second front flight 160b flips to an upright position to catch the front of the incoming second parcel 104.

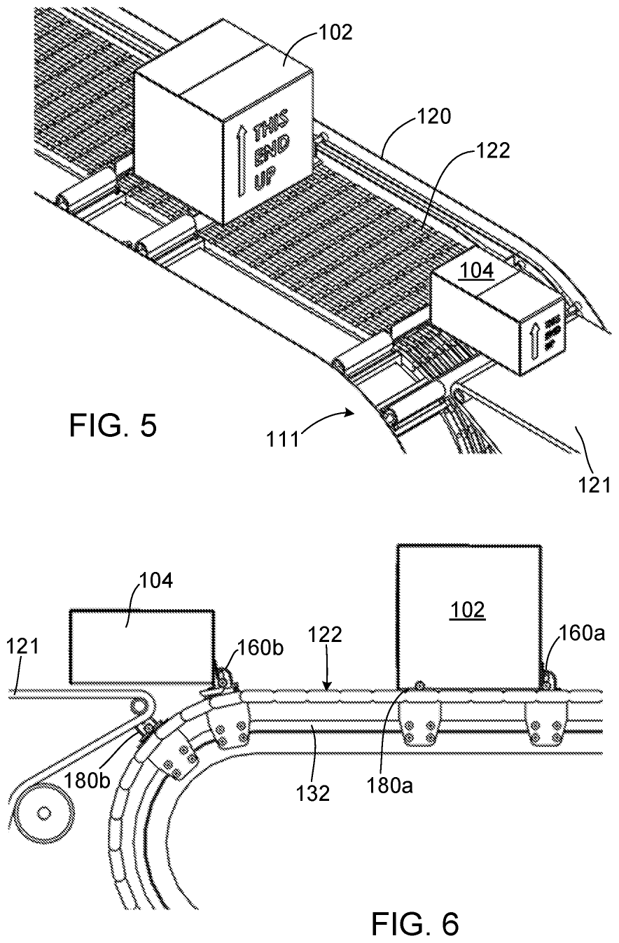

As shown in FIGS. 5 and 6, as the second parcel 104 moves onto the gapping conveyor 120, the second front flight 160b catches the front of the second parcel 104. The second rear flight 180b moves around the input end 111 to support a rear portion of the second parcel 104.

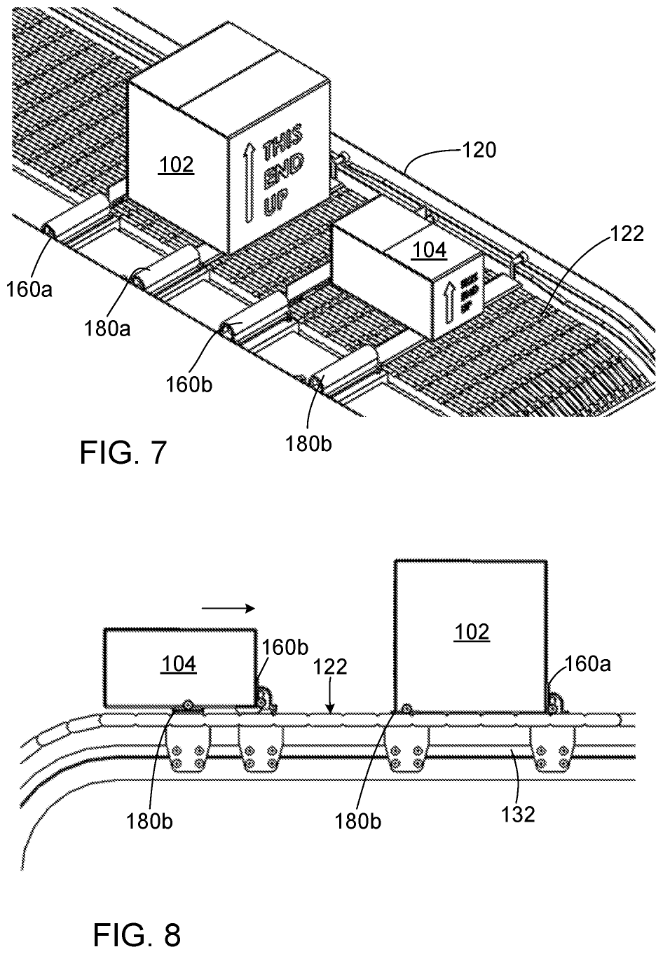

After the second parcel enters the carryway, the second front flight 160b raises above the conveying surface 122 to lift the second parcel 104. After catching the rear portion, the second rear flight 180b also raises above the conveying surface 122. As shown in FIGS. 7 and 8, the second set of flights 160b, 180b can then accelerate the lifted second parcel 104 towards the first parcel 102.

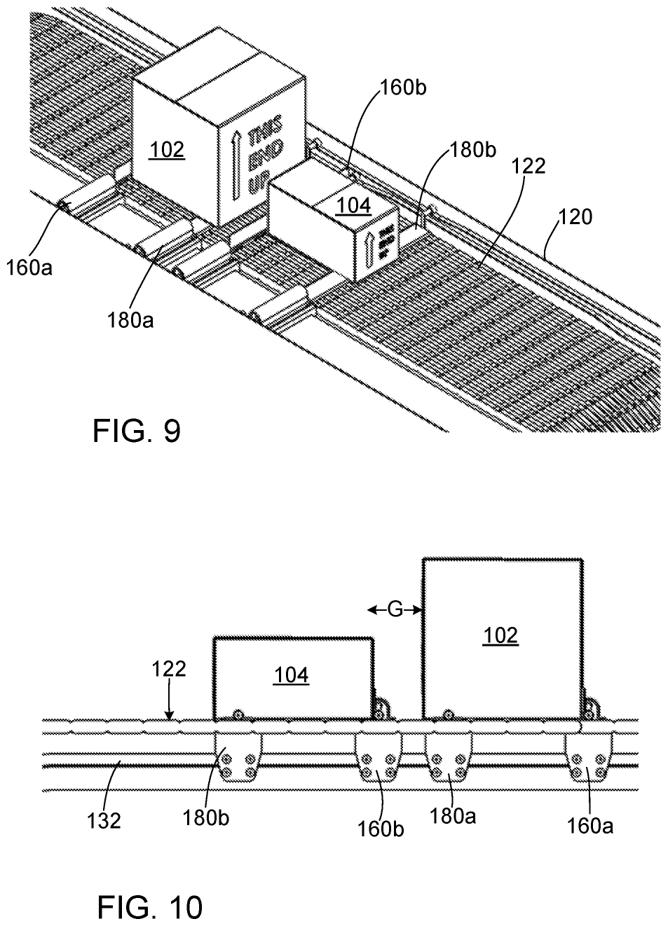

Referring to FIGS. 9 and 10, once the second parcel 104 reaches a location that is a preferred distance from the first parcel 102, the second set of flights 160b, 180b lower, placing the parcel on the conveying surface 122 with a set gap G from the first parcel 102. The parcels 102, 104 can then be conveyed to the output end of the gapping conveyor 122 at the set gap G. In one embodiment, the horizontal panel on the rear flight 180 rests above the conveying surface 122, so that the parcel tips forward slightly, but the invention is not so limited. The flights 160, 180 continue to move with the gapping conveyor 122 to facilitate conveyance of the parcels.

When a front flight 160 reach the end of the gapping conveyor 120, it folds down to release the corresponding parcel onto an output conveyor and returns in the folded-down position to the input end 111 via a returnway to gap another parcel. A rear flight 180 preferably remains in a lowered position for return to the input end 111.

Successive sets of flights can continue to catch, lift, accelerate, gap, convey and release gapped parcels to an output conveyor.

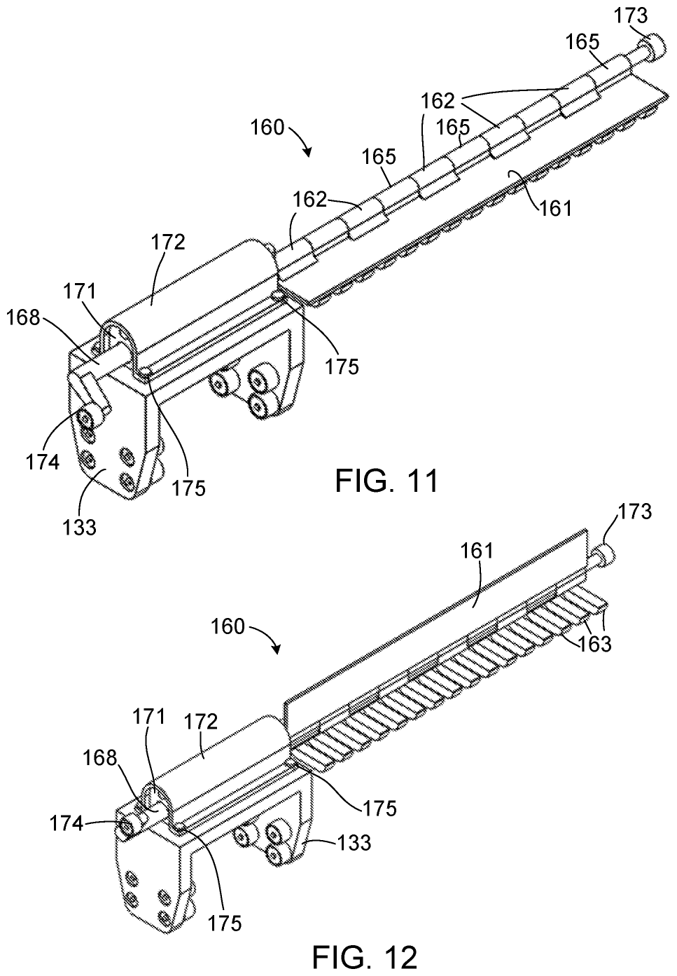

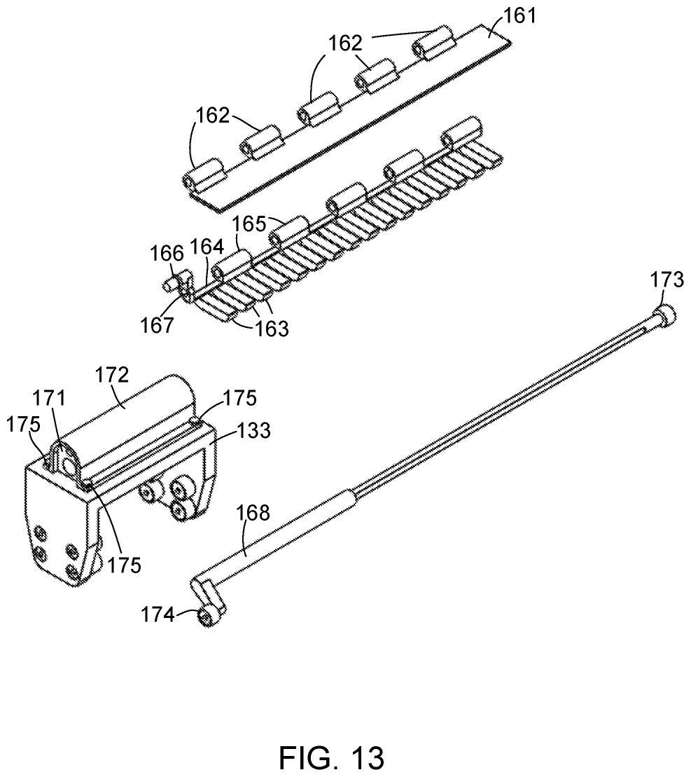

Referring to FIGS. 11-13, an illustrative front flight 160 for selectively catching a front of a conveyed parcel comprises a rotatable panel 161 that include hinge elements 162 spaced along and extending from a first edge. The rotatable panel 161 hingedly connects with a lower portion comprising a lateral connecting bar 164, hinge elements 165 on the lateral connecting bar configured to interleave with the panel hinge elements 162 and longitudinally extending fingers 163. The longitudinally extending fingers 163 are configured to fit in the valleys between longitudinal ribs in an associated conveyor belt 122, but the invention is not so limited. A hinge rod 168 extends through and hingedly connects the rotatable panel 161 to the lower portion.

A sheath 172 is mounted to the top of a mover 133 and includes a bearing support 171 for rotatably receiving the hinge rod 168. The lower portion further includes a lateral protrusion 166 connected to the lateral connecting bar 164 via a connector 167 for connecting the lower portion to the bearing support 171.

The hinge rod 168 includes an aligned cam follower 173 at a first end and an offset cam follower 174 at a second end. The offset cam follower 174 may be used to control the orientation of the rotatable panel 161. When the offset cam follower 174 is in a first position, shown in FIG. 11, the rotatable panel 161 is in a lowered, folded-down position, compressing the front flight 160 to allow passage through a returnway. The offset cam follower 174 can rotate about the hinge rod axis to push the rotatable panel 161 to a raised, vertical position, shown in FIG. 12, which allows the flight to stop the forward motion of parcels that contact the raised vertical panel 161.

In addition, the sheath 172 and bearing support 171 can be movably attached to the mover 133 to allow lifting and lowering of the entire flight portion, including the longitudinally extending fingers 163 relative to the conveying surface 122. The illustrative sheath 172 includes openings for receiving spring-loaded fasteners 175 to movably mount the sheath 172 and bearing support 171 to the mover 133. When the aligned cam follower 173 is pushed up, it will also lift the hinge rod 168 and attached panel 161 and fingers 163 to lift a parcel above the conveying surface 122.

As described below, tracks in the conveyor frame may be used to selectively move the cam followers 173, 174 to control the position and—or orientation of a front flight 160.

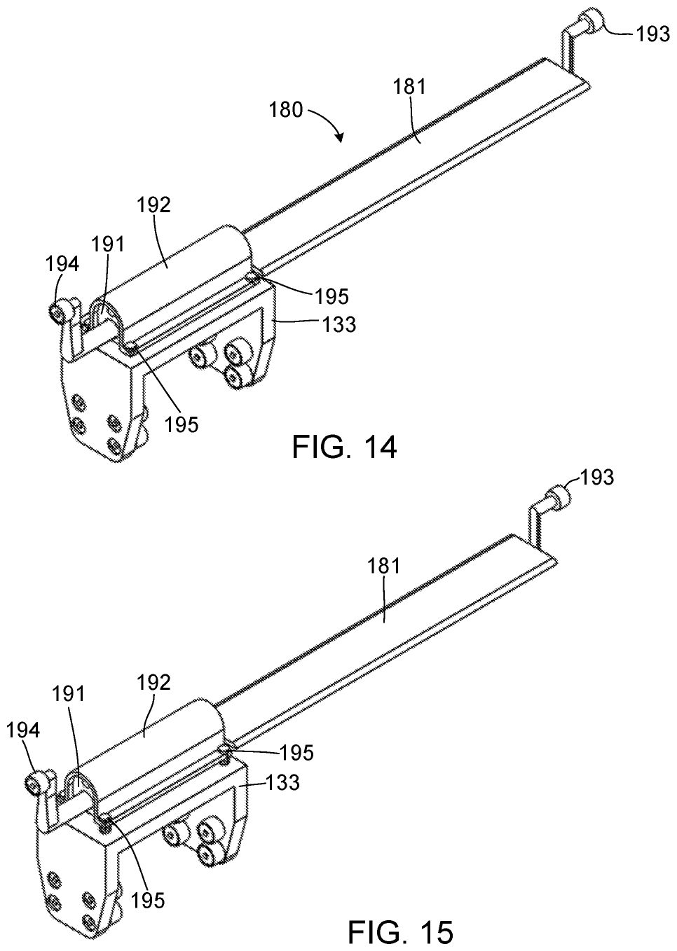

Referring to FIGS. 14 and 15, an illustrative rear flight 180 comprises a flat, substantially horizontal panel 181 connected to a mover 133 via a sheath 192 and bearing support 191. The illustrative sheath 192 may include openings for receiving spring-loaded fasteners 195 to movably mount the sheath 192 and bearing support 191 to the mover 133. Offset cam followers 193, 194 extend from each end of the flight 180 and are connected to the panel 181 by rods and—or projections, but the invention is not so limited. When the cam followers 193, 194 are pushed up, the panel 181 raises up, as shown in FIG. 15, pushing a product supported thereon above a conveying surface. In the lowered position, shown in FIG. 14, the panel 181 may rest directly on top of a conveying surface.

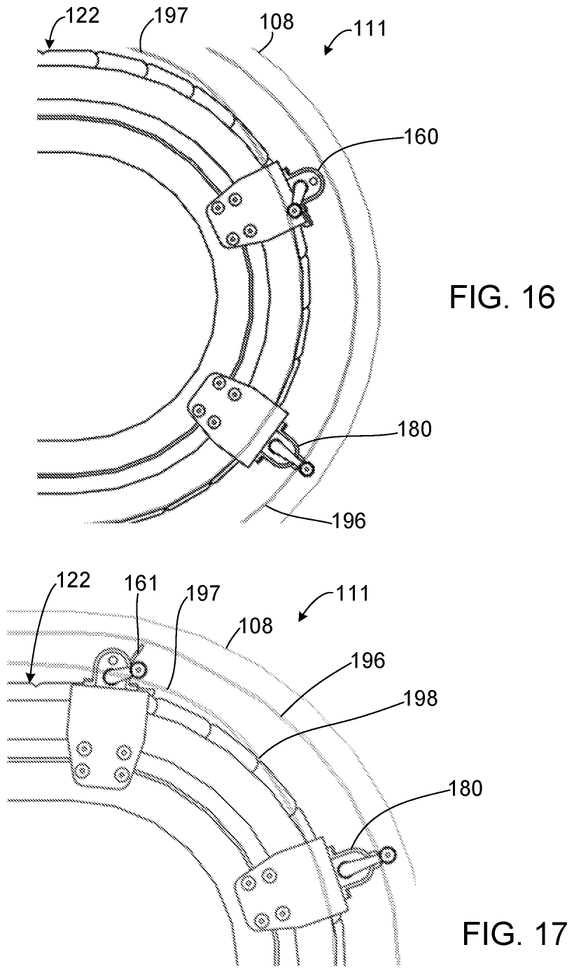

Referring to FIGS. 16-19, a side wall 108 in the frame of the dynamic gapping conveying system 100 can include tracks for controlling the orientation of the front flights 160 and the elevation of the front flights 160 and rear flights 180 relative to a conveying surface 122. An upper track 196 engages cam followers 193 on the rear flights 180. A lower track 197 engages cam followers 173 on the front flight 160. At an input end 111, as shown in FIG. 16, transitioning from a returnway to a carryway, the tracks 196, 197 push the cam followers 193, 173 down relative to the conveying surface 122 so that the flights 160, 180 are lowered and easily fit around the end of the conveyor 120.

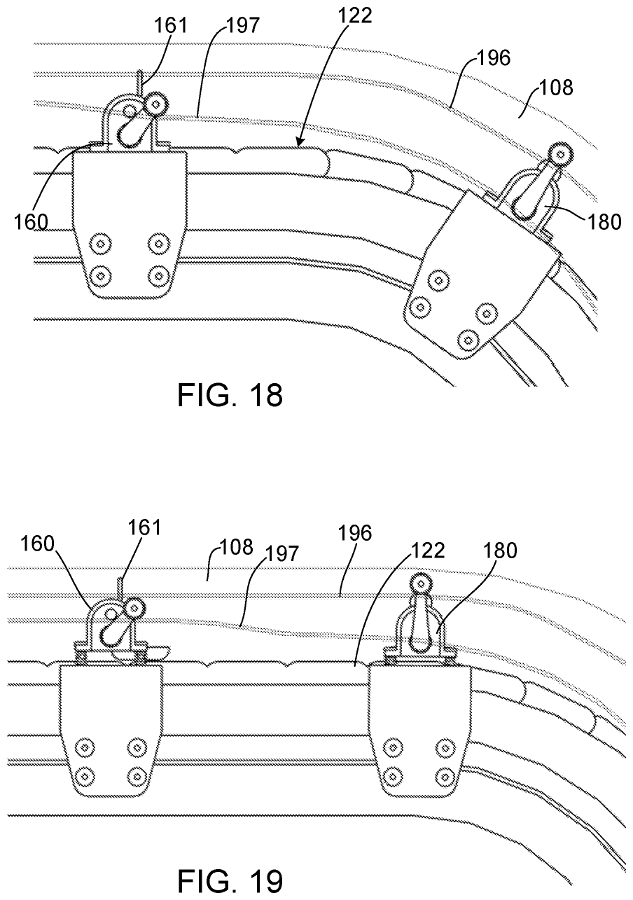

As shown in FIG. 17, at the beginning 111 of the carryway, the lower track 197 rises relative to the conveying surface 122 at point 198, which rotates the rotatable panel 161 to an upright position, while the body of both flights 160, 180 remains at the lowered elevation. The lower track 197 continues to rotate the rotatable panel 161 to the vertical position, as shown in FIG. 18, to catch the front of a parcel. As also shown in FIG. 18, as a rear flight 180 enters the carryway, the upper track 196 begins to lift the horizontal panel 181 of the rear flight relative to the conveying surface 122. As shown in FIG. 19, when the rear flight 180 fully enters the carryway, both flights 160 and 180 are raised and the front flight 160 is in the vertical position.

The tracks 196, 197 may lower the flights at a desired location to place the parcel on the conveying surface 122. The track 197 lowers further at the end of the conveying surface to compress the front flight 160 by rotating the rotatable panel 161 down to facilitate movement through the returnway. Corresponding tracks on a second side of the conveyor may guide the cam followers on the other side of the flights to distribute forces across the flights when lifted.

The invention has been described relative to certain illustrative embodiments. Those skilled in the art will appreciate that the present invention may be implemented in a number of different applications and embodiments and is not specifically limited in its application to the particular embodiments depicted.

What is claimed is:

1. A dynamic gapping conveyor, comprising:
a frame forming a carryway for a conveying surface;
a conveying surface extending in a conveying direction from a first end to a second end and laterally from a first side edge to a second side edge;
a first flight having a rotatable panel extending laterally across the conveying surface for catching a front of a parcel, the first flight connected to a first mover of a linear transport system; and
a second flight having a horizontal panel for supporting the parcel from below, the second flight connected to a second mover of the linear transport system.

2. The dynamic gapping conveyor of claim 1, wherein the first flight includes a first cam follower on a first end, and the frame includes a first track for engaging the first cam follower to selectively rotate the rotatable panel to a vertical position.

3. The dynamic gapping conveyor of claim 2, wherein the first flight comprises a hinge rod connected to the rotatable panel, the hinge rod extending through a bearing support mounted to the first mover, and the cam follower extends from an end of the hinge rod.

4. The dynamic gapping conveyor of claim 3, wherein the bearing support is movably mounted to the first mover using spring-loaded fasteners.

5. The dynamic gapping conveyor of claim 3, wherein the first flight further includes a plurality of longitudinally extending fingers hingedly connected to the rotatable panel.

6. The dynamic gapping conveyor of claim 2, wherein the second flight includes a second cam follower, and the frame includes a second track for engaging the second cam follower to selectively raise the horizontal panel away from the conveying surface.

7. The dynamic gapping conveyor of claim 6, wherein the second flight further includes a bearing support connected to the horizontal panel, and the bearing support is movably mounted to the second mover using spring-loaded fasteners.

8. The dynamic gapping conveyor of claim 1, further comprising a linear transport system comprising an endless rail extending along a first side edge of the conveying surface and a plurality of movers, the endless rail housing a plurality of inducers that interact with the movers to move the movers along the endless rail.

9. The dynamic gapping conveyor of claim 1, wherein the conveying surface comprises a raised rib conveyor belt having a series of longitudinal ribs separated by valleys.

10. A flight for a dynamic gapping conveyor, comprising:
a panel for contacting a parcel;
a rod extending from the panel;
a cam follower connected to the rod for engaging a track in a frame of the dynamic gapping conveyor;
a bearing support housed in a sheath for receiving the rod; and
a plurality of spring-loaded fasteners for mounting the sheath to a mover, so that raising the cam follower causes the panel to raise relative to the mover.

11. The flight of claim 10, wherein the panel is rotatably connected to the bearing support.

12. The flight of claim 10, wherein the cam follower is offset from the rod.

13. The flight of claim 11, further comprising a plurality of longitudinally extending fingers hingedly connected to the rotatable panel and connected to the bearing support.

14. A flight for a conveyor comprising:
a laterally extending panel having a plurality of first hinge elements extending from a first edge;
a lateral connecting bar having a plurality of second hinge elements configured to interleave with the first hinge elements;
a plurality of longitudinally extending fingers extending from the lateral connecting bar;
a hinge rod extending through the interleaved hinge elements;
a bearing support mounted to a mover of a linear transport system for rotatably receiving the hinge rod; and
a cam follower connected to and offset from an end of the hinge rod for engaging a track in a frame of the conveyor so that raising the cam follower rotates the laterally-extending panel to a vertical position.

15. The flight of claim 14, further comprising a sheath for housing the bearing support and a plurality of spring-loaded fasteners for mounting the sheath to the mover, so that raising the cam follower causes the laterally-extending panel to raise relative to the mover.

16. The flight of claim 14, further comprising an aligned cam follower connected to a second end of the hinge rod.

17. The flight of claim 14, further comprising a lateral protrusion connected to the lateral connecting bar via a connector for connecting the lateral connecting bar to the bearing support.
